(19) United States
(12) Patent Application Publication
(10) Pub. No.: US 2004/0007303 A1
(43) Pub. Date: Jan. 15, 2004

(54) Tire with enhanced sidewall

(76) Inventor: Jordan Fishman, Sarasota, FL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/191,062

(22) Filed: Jul. 10, 2002

(51) Int. Cl. B60C 3/06; B60C 3/00; B60C 13/00; B60C 15/00

(52) U.S. Cl. 152/454; 152/456; 152/539; 152/544; 152/526; 152/554

(57) ABSTRACT

A pneumatic tire for heavy duty use applications, having at least one sidewall of formed an increased thickness, for providing better tire sidewall wear and increased re-use of the tire's internal carcass, the tire's enhanced thickness sidewall having a relief area formed by at least one radius relief portion adjacent that sidewall's bead to prevent the associated rim flange edge from cutting into the enhanced thickened sidewall, and a sharp angled return sidewall portion adjacent the portion tread sidewall. The increased thickened sidewall, ranging between approximately 2.0 and 3.5 inches, provides maximum thickness in the area of maximum sidewall flexing during use.

### FIELD OF THE INVENTION

This invention relates to tires for heavy-duty use applications, particularly to a pneumatic tire having at least one, preferably the outer, sidewall formed of extra thickness for heavy-duty wear purposes.

### BACKGROUND OF THE INVENTION

Pneumatic tires used in heavy-duty applications, e.g., on mining machines, forklifts, and other industrial equipment, and the like, often have an extra thick tread section. Nevertheless, they typically have relatively thin sidewalls, for example, of only ⅜ to ½ inch thickness. Such heavy duty use tires often encounter severe cuts and damaging blows to the sidewall area, caused by hitting rocks, concrete curbs, warehouse rack frames, pallets, and other pieces of equipment, and obstacles. Thus, the outer sidewall areas on such heavy-duty application tires are often destroyed prematurely, or because of the impact the carcass is damaged to the point of early failure. Further, the outer edge of the associated rim flange on many heavy duty tires is not sufficiently protected by the tire's sidewall causing the flange to be bent and broken to the point of causing the tire itself to become a “leaker” or unusable.

Further yet, a heavy duty use tire's internal carcass member can be damaged, in the sidewall areas, if not properly protected, thereby rendering a shorter overall life for the carcass, which normally should be able to be reused and re-treaded several times.

Past attempts at heavy-duty application tires did not prove to be commercially satisfactory, i.e., since they did not have sufficient upper sidewall thickness (in the areas nearest the tread), to prevent sidewall tearing problems in that area. Further, in the past there were always inherent difficulties in the thickness (actually “thinness”) of the sidewall in such heavy-duty application tires, i. e., at the very area where a substantial amount of sidewall damage normally occurs.

### SUMMARY OF THE INVENTION

The present invention seeks to overcome the deficiencies in the prior art by providing a non-symmetrical tire having an extra thick sidewall on the outer wall of the tire, i.e., the sidewall facing outside and away from the machine on which the tire is mounted. The asymmetrical design is required because of the very close inside tolerances associated with equipment of this type. This thick sidewall of the present invention is intended to be sufficiently flexible to provide a relatively smooth ride for the tire, yet also be sufficiently thick to provide protection for the overall tire and its internal carcass in its working environment.

More specifically, the present invention provides a heavy-duty use pneumatic tire with an enhanced thickened sidewall on at least one side of the tire to protect against sidewall wear, with a specifically configured double arch-shaped relief area near the wheel hub's rim flange to prevent undesired contact during tire use of the thickened sidewalls with the associated metal rim flange. The sidewall's enhanced thickness portion extends substantially the full vertical height of the tire's sidewall, i.e., from near the bead to substantially adjacent the tire's tread area, and further. The uppermost outer edge of the enhanced thickened sidewall portion is formed with a substantially sharp return angle to the upper sidewall area. Further, sufficient so-called “rubber flow through” occurs during the tire molding process in the enhanced sidewall and tread areas with the utilization of breaker plies having less ends per inch than the remaining carcass plies, all to help strengthen and bind the thick sidewall and thick tread portion to the tire's internal carcass. This is accomplished by using, in the last few uppermost or breaker plies, a lesser number of inch ends of fibers per ply, and to have the breaker ties extend substantially into the sidewall area. This, in turn, results in also having in essence a tread area on the upper sidewall region.

### BRIEF DESCRIPTION OF THE DRAWINGS

The means by which the foregoing and other aspects of the present invention are accomplished and the manner of their accomplishment will be readily understood from the following specification upon reference to the accompanying drawings, in which:

FIG. 1 depicts in cross section the sidewalls, carcass profile, and outer tread portions of a pneumatic tire made in accordance with the present invention;

FIG. 2 depicts another cross section view of the tire of FIG. 1, depicting the enhanced sidewall with associated carcass and ply configuration; and

FIG. 3 is a top plain view of a portion of the tire, further depicting the thickness of the thick sidewall.

### DETAILED DESCRIPTION OF THE INVENTION

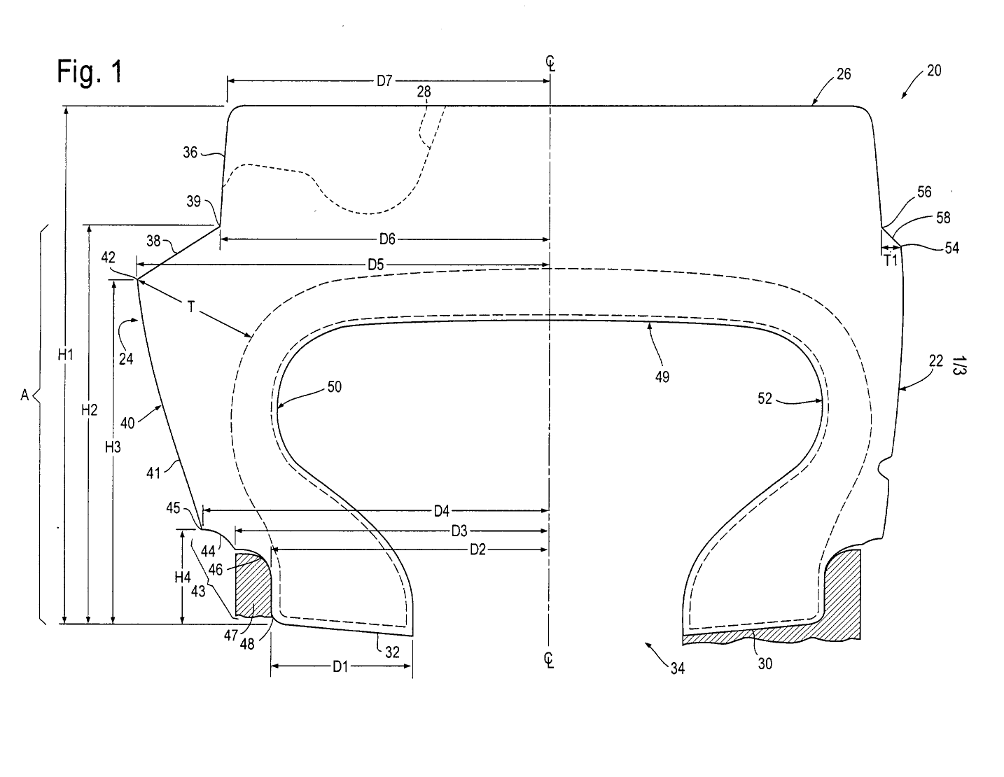

Having reference to the drawings, wherein the like reference numerals indicate corresponding elements, there is shown, in FIG. 1 (which is drawn as a tire mold drawing but which accurately represents the finished tire) a cross section view of a pneumatic tire made in accordance with one aspect of the present invention, the tire being generally denoted by reference numeral 20.

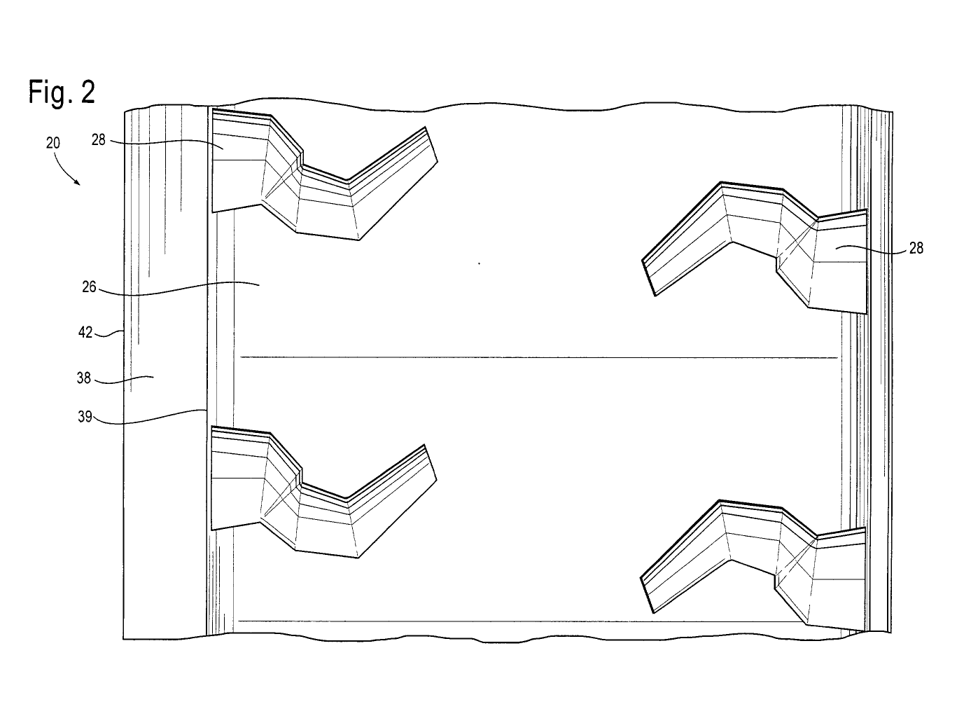

Tire 20 includes an inner sidewall portion 22 (shown to the right in FIG. 1), an outer sidewall portion 24 (to the left in FIG. 1), and an outer or uppermost tread portion 26 formed between the two sidewalls. A hidden (in FIG. 1) portion of the tread 26 is depicted in phantom by reference numeral 28 and the tread also appears in FIG. 2. However, no specific tread design for tire 20 is claimed as part of the present invention. The lower portion of the respective sidewalls 22, 24 terminate respectively in flange walls 30, 32, which between them form the opening 34 to allow mounting of the tire 20 on a wheel or rim (not shown) having a rim flange 47. The present invention is directed, in part, to the enhanced, i.e., thickened, sidewall present along substantially the vertical extent of outer sidewall portion 24, as denoted by reference letter A. More specifically, outer sidewall portion 24, starting at the tread portion 26, includes an upper sidewall portion 36, a sharp, angled upper sidewall portion 38 and an elongated sidewall portion 40 with a sidewall crown 42 therebetween, and a relief area 43 formed of an outer radius portion 44, an inner radius portion 46, and terminating in a lower curved corner bead edge 48. As seen in FIG. 1, the typical hub rim flange 47 provides the mounting environment for the tire 20 of the present invention.

Shown generally by reference numeral 50 is the outer profile of the tire's carcass along outer sidewall 24. As seen, the thickened portion A of the outer sidewall 24 extends at its lowest point from inner radius portion 46 on through to its upper point at intersection point 39 of the angled sidewall 38. This results in a substantially thickened outer sidewall, which at its widest point has a thickness (measured from sidewall crown 42 to the outer carcass profile 50) designated as thickness “T”.

It will be noted that angled sidewall portion 38 is preferably generally linear. However, the elongated sidewall portion 40 is preferably formed with a surface 41 generated by an elongated radius “R”. This results in a smooth curved surface 41 along outer sidewall portion 40.

In one heavy-duty use tire made in accordance with the present invention, having a generally 14.50-15 size, the overall sidewall height, designated by reference letter H1 in FIG. 1, was approximately 10.5 inches; the height H2 representing the height of the tire from the bead edge 48 to the upper end of upper sidewall 38 was 7.8 inches; the height H3, representing the height from the bead edge 48 to the sidewall crown 42, was 6.8 inches; and height H4, representing the height distance between the tire's bead 32 and intersecting point 45 of elongated sidewall 40 and outer radius portion 44, was approximately 2.0 inches.

Further for that same tire, the width distance, as generally denoted by reference letter D1 in FIG. 1, representing the length of the bead 32 of tire 20, was 2.2 inches; the width distance D2 from the tire's center line (designated by reference letter CL) to the rim flange wall 47, was 6.2 inches; the width distance D3 from the tire's center line CL to the intersection of respective outer and inner radius portions 44, 46, was 6.85 inches; the width distance D4 from the tire's center line CL to the intersection of outer radius portion 44 and the lower edge of elongated sidewall 40, was 6.8 inches; the widest dimension of the tire, namely distance D5, running from the tire's center line CL to the sidewall crown 42, was 8.1 inches; the width distance D6 from the tire's center line CL to the upper edge of angled upper sidewall 38, was 6.6 inches; and the width distance D7 from the tire's center line CL to the upper edge of upper sidewall 36, was 6.3 inches.

As seen then, in that one example of a tire made in accordance to the present invention, the thickness T (between the outer sidewall carcass profile 50 and sidewall crown 42) was approximately 2.7 inches. Thus, instead of having a sidewall thickness of only approximately 0.375 inches, as was commonly present in prior art heavy-duty use tires, the sidewall thickness T of a tire made in accordance of the present invention is substantially thicker, and namely by some 2.325 inches. That is approximately a 620% increase in sidewall thickness. Preferably, the thickness T will range from approximately 2.0 inches to 3.5 inches, depending upon the present tire's sidewall design, its tread design, the tire's overall size, and the ultimate intended end use for the enhanced sidewall tire in question, such that the extra sidewall thickness T can be between some 433% and 833% greater than the thickness of the normal prior art sidewall.

Reference 52 shows the internal carcass profile along the inner sidewall (on the right side of tire 20 of FIG. 1). As seen then, the thickness T (between carcass profile 50 and sidewall crown 42), is substantially different and larger than the corresponding thickness Ti (between inner sidewall carcass profile 52 and the upper edge 56 of the right side's narrow, angled upper sidewall 58). That extra thickness present in outer sidewall 24 causes it to provide substantial protection to tire 20 and its carcass 49 from blows to the outer sidewall as often encountered during normal heavy duty use. That enhanced thickness of the outer sidewall 24 permits, in turn, substantial numbers of re-use and retreadings for the tire carcass 49. In combination with the thickened sidewall 40, the relief radius portions 44, 46 help prevent the metal rim flange edge 47 from cutting into the outer sidewall 24.

Preferably, the height H4 (FIG. 1) varies within the range from approximately 1.7 inches to 3.0 inches. This range is chosen so as to prevent the outer edge of rim flange 47 from cutting into the outer sidewall 24, yet also not be so large that rocks, debris, and other undesirable materials can easily lodge and wedge within the areas of respective outer and inner radius portions 44, 46 and rim flange edge 47. Thus, the lower end of sidewall 24 is sufficiently relieved in thickness, at relief area 43 via the two radius portions 44, 46, to prevent the metal rim flange edge 47 from undesirably cutting into the tire's thickened sidewall and also from undesirably being bent itself by that thickened sidewall, which can cause tire “leaker” conditions.

As seen in FIG. 1, the upper extent, i.e., reach, of the enhanced thickened portion A of outer sidewall 24 extends to the full height of distance H₂, namely, to the height of intersection point 39 (that point between angled sidewall 38 and upper sidewall 36). In that manner, the enhanced thickness of outer sidewall 24 extends up into the area of upper sidewall 36. Preferably, distance H₂ extends to within the range of from approximately 60% to 85% of the radial height H₁ of the tire's sidewall. This allows there to be substantial sidewall thickness (represented by thickness T) present exactly at the point in the tire's outer sidewall 24 where the most flexing occurs during heavy duty use. In the prior art tires there was substantial tearing experienced along this general location, as the customary thin sidewalls of prior art tires were unable to sustain extended severe blows and stress at that area. However, the present invention's enhanced outer sidewall 24, which has an enhanced thickness A extending up into the upper sidewall, solves this problem. Further yet, the high, thick sidewall 24 of the present invention operates to provide a smooth ride for the heavy duty use tire 20.

It will be understood that the enhanced sidewall of the present invention could also be used with so-called “smooth” heavy-duty tires (not shown) where there is a smooth outer wall instead of a tread portion, such as used in hard rock mining operations. In those instances the thickened sidewall portion A, per distance H₂, can extend up higher, and to as much as 90% of the radial height of the sidewall, i.e., towards the smooth tread portion.

If needed for specific end use situations, it will be understood that both inner and outer sidewalls 22, 24 can be formed of thickened sidewall portions (whether both have the same enhanced thickness T, or otherwise), such that the inner sidewall 22, along with the thickened outer sidewall 24, can be enhanced and thickened (not shown) to help prevent premature wear of both the sidewalls of the tire.

Preferably, the tire's carcass 49 (with thick and thin sidewall carcass profiles shown generally by reference numerals 50, 52 respectively) is formed of several plies of fibers. Such ply fibers are preferably formed of Nylon cord materials. Further, the tire is molded over the carcass 49 in a known manner by use of a molded rubber compound, such as formed of natural rubber, synthetic rubber, carbon black, various other known tire molding chemical materials, and mixtures thereof.

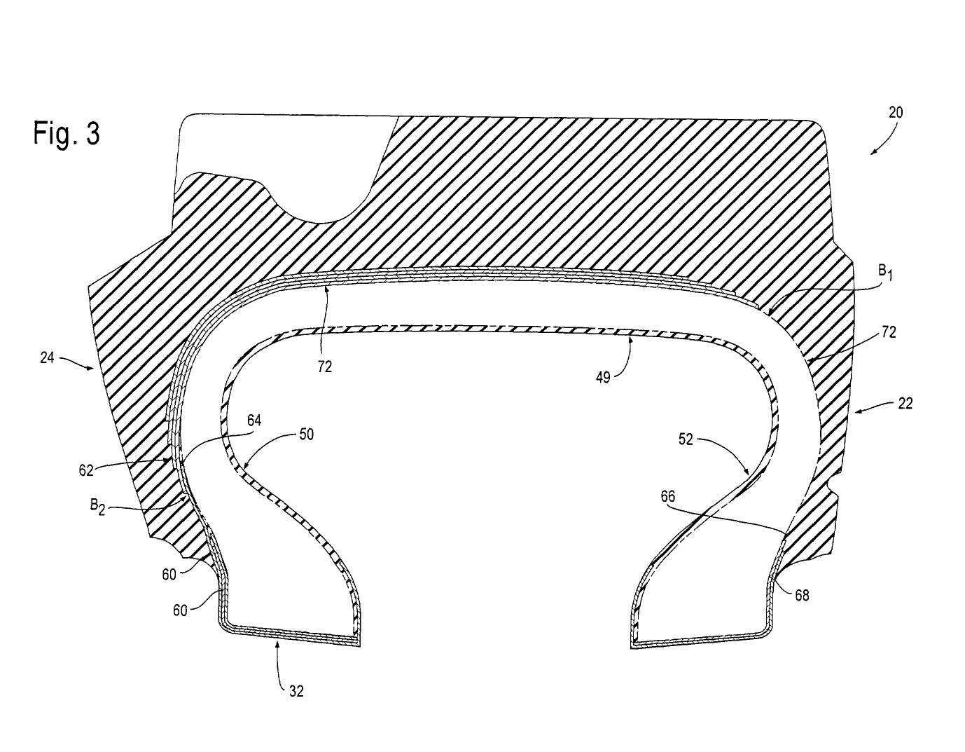

As seen in FIG. 3, there is shown the special carcass configuration 49 as used for enhanced sidewall tire 20. Carcass 49 includes a series of turn-up plies 60 which extend from inner end of tire bead 32 up along the outer carcass wall 62 (of enhanced sidewall portion 24) and stopping at an upper turn-up ending 64. These turn-up plies 60, which extend up enhanced sidewall 24 to a further height then turn-up ending 66 of turn-up plies 68 on inner sidewall 22, help protect the generally lower half of elongated enhanced sidewall portion 40 of thickened sidewall 24.

Further, a series of breaker plies 70 are laid against the outermost carcass ply 72 and extend (at their rightmost end in FIG. 3) from point B₁ to point B₂ (at their leftmost end in FIG. 3), which is at a point extending over the outermost turn-up ply 60 at upper turn-up ending 64. That is, instead of being normally centered relative to the tread so as to straddle the outermost carcass ply 72 (as in prior art tires), the breaker plies 70 of the tire 20 of the present invention are formed to cover and protect both the upper tread portion 26 and the generally upper half of enhanced sidewall 24. As seen, the lowermost portion of sidewall breaker plies 70 overlie the uppermost portion of outer turn-up plies 60, and hence, cooperate to provide enhanced sidewall 24 with extra protection all along its length.

Further yet, the breaker plies 70 are formed to be of lesser ply ends per inch than the other plies making up carcass 49. That is, breaker plies 70 are preferably formed to contain from 10 to 15 ends per inch, and more preferably, 13 ends per inch, whereas the remaining or innermost plies forming carcass 49 are formed to contain form 20 to 24 ends per inch. Thus, it will be understood that, during tire molding, the lesser-ends-per-inch ply material used for breaker plies 70 allows more so-called “rubber flow through” to occur through and between the breaker plies, i.e., where they are positioned along tread wall and enhanced sidewall portions of carcass 49. This, in turn, helps better bond the thick sidewall portion 24, and also thick tread portion 26, to the carcass 49 during the tire molding process to provide improved tire wear and protection.

Overall, the presence of a substantially thickened yet flexible sidewall on at least one of the sidewalls of the present heavy-duty use tire achieves substantial reduction in the cutting and damage of the tire's outer sidewall during use, and also helps greatly protect the tire's carcass, so that it can advantageously be reused and retreaded several times. The relief area near the inner flange of the thickened sidewall prevents unwanted cutting and damage to the thickened sidewall by the associated metal rim flange edge.

From the foregoing, it is believed that those skilled in the art will readily appreciate the unique features and advantages of the present invention over previous types and designs of heavy duty use pneumatic tires. Further, it is to be understood that while the present invention has been described in relation to a particular preferred embodiment as set forth in the accompanying drawings and as above described, the same nevertheless is susceptible to change, variation and substitution of equivalents without departure from the spirit and scope of this invention. It is therefore intended that the present invention be unrestricted by the foregoing description and drawings, except as may appear in the following appended claims.

What is claimed is:

1. Tire for heavy duty use, comprising:
tire carcass covered with molded rubber compound to form a pneumatic tire, the tire having respective sidewalls and an outer tread there between, each sidewall at its radially innermost end formed with a bead, and at its radially outermost end formed with an upper sidewall portion;
at least one sidewall formed as a thickened sidewall having a greater thickness then the other sidewall, said one sidewall having at least one radius relief portion formed adjacent the bead for that one sidewall, an elongated outwardly and radially-extending thickened sidewall portion, and an angled return sidewall portion terminating in the upper sidewall portion thereof.

2. The tire of claim 1, wherein the thickest sidewall portion along the one sidewall is in the range from between approximately 433% and 833% greater than the thickest portion of the other sidewall.

3. The tire of claim 1, wherein the thickened sidewall of the one sidewall has a thickness in the range from approximately 2.0 inches to 3.5 inches.

4. The tire of claim 1, and the one sidewall having a second radius relief portion formed adjacent and radially outward of the at least one radius relief portion.

5. The tire of claim 4, wherein the height of the radially outermost portion of the second radius relief portion from the one sidewall's bead is in the range from approximately 1.5 inches to 3.5 inches.

6. The tire of claim 1, wherein the radial height of the thickened sidewall off that one sidewall's bead relative to the overall sidewall height of the tire is in the range from approximately 60% to 90%.

7. The tire of claim 1, and wherein the tire carcass is formed of multiple layers of cord plies, the outermost series of ply layers formed as breaker plies along the tread wall and upper portion of the thickened sidewall and formed to contain less ends per inch than the innermost series of ply layers, whereby enhanced rubber flow through of molded rubber compound is permitted between the tire carcass and both the upper portion of the thickened sidewall and the tread due to the less ends per inch of the breaker plies.

8. The tire of claim 7, wherein the breaker ply layers comprise between 2 and 4 plies.

9. The tire of claim 8, wherein the innermost series of ply layers comprises between 12 and 16 plies.

10. The tire of claim 8, wherein the less ends per inch of the breaker ply layers contains in the range of approximately 10 to 15 ends per inch.

11. The tire of claim 10, wherein the less ends per inch is 13 ends per inch.

12. The tire of claim 7, wherein the ends per inch in the innermost series of ply layers is in the range of approximately 20 to 24 ends per inch.

13. The tire of claim 7, and turn-up plies formed as the outermost ply layers on the tire carcass in the location along the bead and extending up to a turn-up ending adjacent the breaker plies on the thickened sidewall.

14. A pneumatic tire for heavy-duty use, comprising
a tire carcass covered with molded rubber compound;
an outer sidewall;
an inner sidewall;
a tread formed between the outer and inner sidewalls;
at least one of the outer and inner sidewalls being formed as a thickened protective sidewall having at the greatest thickness thereof a sidewall thickness in the range from approximately 2.0 to 3.5 inches; and
a relief area formed in the thickened sidewall adjacent the innermost radial end thereof to substantially remove the thickened sidewall from contact with the associated wheel hub rim flange.

15. The pneumatic tire of claim 14, and wherein an upper sidewall is formed on the thickened sidewall, and the upper end of the thickened sidewall terminates in a sharp return angle to the upper sidewall area.

16. The pneumatic tire of claim 15, wherein the relief area is formed of at least one radiused relief portion.

17. The pneumatic tire of claim 14, wherein the radially outermost height of the relief area is in the range, as measured off the radially innermost portion of the tire, of from approximately 1.5 to 3.0 inches.

18. The pneumatic tire of claim 14, and wherein the greatest thickness of the thickened sidewall is in the range from approximately 2.5 to 2.9 inches.
